(19) United States
(12) Patent Application Publication
(10) Pub. No.: US 2026/0251146 A1
(43) Pub. Date: Aug. 27, 2026

(54) Multistage Centrifugal Compressor

(71) Applicant: Hitachi Industrial Products, Ltd., Chiyoda-ku, Tokyo (JP)

(72) Inventors: Masahiro OKADA, Tokyo (JP); Kiyotaka HIRADATE, Tokyo (JP)

(21) Appl. No.: 18/872,440

(22) PCT Filed: Apr. 25, 2023
(86) PCT No.: PCT/JP2023/016335

§ 371 Date: Dec. 6, 2024

(30) Foreign Application Priority Data
Jun. 9, 2022 (JP) 2022-093822

(51) Int. Cl. F04D 17/12; F04D 29/44

(52) U.S. Cl. CPC F04D 17/122; F04D 29/444

(57) ABSTRACT

A multistage centrifugal compressor includes a rotational shaft, a centrifugal impeller fixed to the rotational shaft, and a return flow path formed by a shroud and a hub. In the return flow path, a radial flow path, an L-shaped bend flow path, and an axial flow path form an L-shaped flow path. A return vane is arranged in the radial flow path and the L-shaped bend flow path. A portion of a rear edge of the return vane near a hub-side connection part has a linear shape and a portion of the rear edge of the return vane near a shroud-side connection part has a curved shape protruding downstream, the rear edge of the return vane extended toward an inner radial side to an inside of the L-shaped bend flow path. The hub-side connection part of the return vane is on the inner radial side of the shroud-side connection part.

### TECHNICAL FIELD

The present invention relates to a multistage centrifugal compressor.

### BACKGROUND ART

An inside of the centrifugal compressor is formed of a centrifugal impeller, a diffuser, a return channel that is a flow path to the next stage, and the like.

The centrifugal impeller provides energy to a fluid by rotating. The diffuser converts dynamic pressure of the fluid increased by the centrifugal impeller, to static pressure. Return vanes for removing a swirl velocity component of the fluid about a rotational shaft of the centrifugal impeller are arranged in the return channel.

When the fluid passes the return channel, the fluid passes the return vanes arranged at equal intervals in the circumferential direction about the center axis of the rotational shaft. This causes the fluid to come into contact with the return vanes, and the swirl velocity component of the fluid is removed. However, loss is generated when the swirl velocity component of the fluid is not sufficiently removed, and it is generally known that the loss reduces energy providing efficiency and the pressure increase of the fluid in the impeller of the next stage.

Structures for efficiently turning a flow with return vanes to remove a swirl velocity component of a fluid and straightening the flow are proposed in Patent Literatures 1 and 2.

### CITATION LIST

### Patent Literature

Patent Literature 1: JP2018-135815A (FIGS. 2, 5, and 6, paragraphs 0042 and 0043, paragraphs 0055 and 0058)

Patent Literature 2: JP2018-178769A (FIG. 4, paragraphs 0023 to 0026)

### SUMMARY OF INVENTION

### Technical Problem

First, problems to be solved by the invention are explained with reference to FIGS. 8 to 10 showing a conventional centrifugal compressor 200.

FIG. 8 shows a meridional plane view showing an upper half of an entire configuration of the conventional centrifugal compressor 200.

FIG. 9 shows a partial enlarged cross-sectional view of an outline of the conventional centrifugal compressor 200.

In an inner flow path of the centrifugal compressor 200 shown in FIG. 8, regarding a static flow path formed of an outer diameter of an impeller 101, a diffuser 103, and a return channel 104, joining an inner structure to an outer structure via a return vane 105 forms the static flow path (outer diameter of 101, 103, and 104) as shown by parts in a hatched portion of FIG. 9. The return channel 104 includes a turnaround portion 106a, a turnaround portion 106b, and the return vane 105.

As shown in FIG. 8, the impeller 101, the diffuser 103, and the return channel 104 are housed in a casing 130.

An intake flow path 132 and a discharge flow path 133 are provided in the casing 130. A fluid before compression is taken in from the intake flow path 132. The fluid pressurized in the impeller 101, the diffuser 103, the return channel 104, and the like is discharged from the discharge flow path 133.

In this case, when the return channel 104 is moved toward the inner radial side for size reduction of the multistage centrifugal compressor 200, an increase in the velocity of the fluid flowing in the static flow path (outer diameter of 101, 103, and 104) and a decrease in the vane length of the return vane 105 cause a problem of flow separation due to rapid deceleration and rapid turning of the flow and a problem of an increase of a swirl velocity component at an exit of the return vane 105.

FIG. 10 shows a cross section in the case where a return vane rear edge 105k in the partial enlarged view of the conventional design shown in FIG. 9 is extended toward the inner radial side to an inside of an L-shaped bend flow path 107, while maintaining a linear shape.

The L-shaped bend flow path 107 and an axial flow path 108 are formed downstream of the return vane 105, and lead to the impeller 101, the diffuser 103, and the return channel 104 of the next stage.

Assume a case where, in a large-capacity stage in which the width of the static flow path (outer diameter of 101, 103, and 104) is large, the return vane rear edge 105k is extended to the inside of the L-shaped bend flow path 107 on the inner radial side while maintaining the linear shape on a meridional plane to secure the vane length of the return vane 105. In this case, there occurs such a problem that a pre-swirl velocity component of the fluid remains in an area from the shroud side 105k1 of the return vane rear edge 105k to a portion near the flow path height center (near the middle of the return vane rear edge 105k) and, conversely, a counter swirl velocity component increases near the hub side 105k2n . The pre-swirl velocity component is a velocity component in a rotation direction of the impeller 101. The counter-swirl velocity component is a velocity component in the opposite direction to the rotation direction of the impeller 101.

In a technique described in Patent Literature 1, as shown in FIG. 2, a hub-side connection part of a rear edge of a return vane (50) is on the radial direction outer side of a shroud-side connection part, and a sufficient vane length of the return vane (50) is not secured. Removal of the swirl velocity component of the fluid flowing on the hub side is thus difficult.

Similarly, in the technique described in Patent Literature 2, as shown in FIG. 4, a connection part, on the hub side (17), of a rear edge of a swirl removal member (13) arranged downstream of a return vane (11) is on the radial direction outer side of a connection part on the shroud side (16). Accordingly, removal of a swirl velocity component of a fluid flowing on the hub side (17) is difficult.

The present invention has been invented in view of the above-mentioned situations, and an object is to provide a multistage centrifugal compressor that can remove a swirl velocity component in a whole range, in a flow path height direction, from a shroud to a hub forming a radial flow path of a return flow path.

### Solution to Problem

To solve the above-mentioned problems, a multistage centrifugal compressor of the present invention includes: a rotational shaft; a centrifugal impeller fixed to the rotational shaft; and a return flow path formed by a shroud and a hub, in the return flow path, a radial flow path, an L-shaped bend flow path, and an axial flow path form an L-shaped flow path, a return vane is arranged in the radial flow path and the L-shaped bend flow path, a portion of a rear edge of the return vane near a hub-side connection part has a linear shape and a portion of the rear edge of the return vane near a shroud-side connection part has a curved shape protruding downstream, the rear edge of the return vane extended toward an inner radial side to an inside of the L-shaped bend flow path, and the hub-side connection part of the return vane is on the inner radial side of the shroud-side connection part.

### Advantageous Effects of Invention

The present invention can provide a multistage centrifugal compressor that can remove a swirl velocity component in a whole range, in a flow path height direction, from a shroud to a hub forming a radial flow path of a return flow path.

### BRIEF DESCRIPTION OF DRAWINGS

FIG. 1 is a meridional plane view showing an upper half of an entire configuration of a centrifugal compressor according to Embodiment 1 of the present invention.

FIG. 2 is a partial enlarged cross-sectional view of a main portion of the centrifugal compressor shown in FIG. 1.

FIG. 3 is a cross-sectional view in which a return vane is viewed in an axial direction.

FIG. 4 is an enlarged cross-sectional view of a return vane rear edge according to the present invention.

FIG. 5A is a table showing a suppression percentage of a swirl angle in each of four divided sections of flow path height in an axial flow path in the case where a return vane rear edge with a linear shape in a conventional design (comparative example) shown in FIG. 10 is replaced with the return vane rear edge with a curved shape in Embodiment 1 shown in FIG. 2.

FIG. 5B is a graph showing the suppression percentage of the swirl angle in each of the four divided sections of the flow path height in the axial flow path in the case where the return vane rear edge with the linear shape in the conventional design (comparative example) shown in FIG. 10 is replaced with the return vane rear edge with the curved shape in Embodiment 1 shown in FIG. 2.

FIG. 6 is a cross-sectional view in which a return vane divided into two rows of front vanes and rear vanes in Embodiment 2 is viewed in the axial direction.

FIG. 7 is a view showing a positional relationship of the front vanes and the rear vanes shown in FIG. 6 in Embodiment 2.

FIG. 8 shows a meridional plane view showing an upper half of an entire configuration of a conventional centrifugal compressor.

FIG. 9 shows a partial enlarged cross-sectional view of an outline of the conventional centrifugal compressor.

FIG. 10 is a view showing a cross section in the case where a return vane rear edge in the partial enlarged view of the conventional design shown in FIG. 9 is extended toward the inner radial side to an inside of an L-shaped bend flow path, while maintaining a linear shape.

### DESCRIPTION OF EMBODIMENTS

Embodiments of the present invention are explained below in detail with reference to the drawings as appropriate.

The present invention relates to a multistage centrifugal compressor, and particularly relates to a centrifugal compressor in which return vanes are arranged in a return flow path forming a static flow path.

The embodiments of the present invention are explained in detail with reference to the drawing as appropriate.

Note that, in the drawings described below, the same members or corresponding members are denoted by the same reference numerals, and overlapping explanation is omitted as appropriate. Moreover, the sizes and shapes of the members are sometimes schematically shown while being deformed or exaggerated for convenience of explanation.

### Embodiment 1

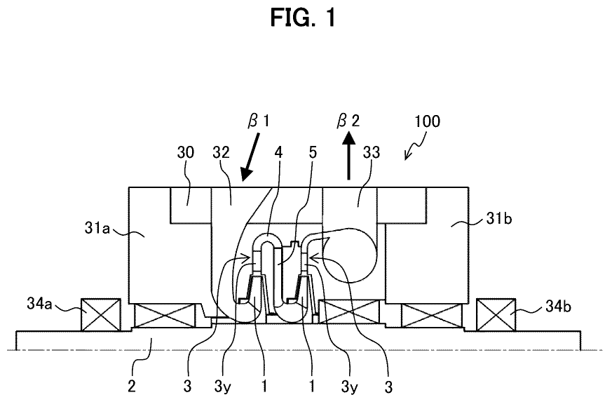

FIG. 1 shows a meridional plane view showing an upper half of an entire configuration of a centrifugal compressor 100 according to Embodiment 1 of the present invention.

The centrifugal compressor 100 of Embodiment 1 is explained.

The centrifugal compressor 100 provides rotational energy to a fluid by using centrifugal impellers 1, and converts the rotational energy to energy of pressure of the fluid.

The centrifugal compressor 100 is configured to schematically include the centrifugal impellers 1, a rotational shaft 2 to which the centrifugal impeller 1 is attached, and diffusers 3.

The rotational shaft 2 is rotatably supported by a radial bearing 34a and a radial bearing 34b arranged on both end sides of the rotational shaft 2 in an extending direction thereof.

Rotation of the rotational shaft 2 causes the centrifugal impellers 1 to rotate in the fluid and provide the rotational energy to the fluid.

The diffusers 3 are provided on the outer side of the respective centrifugal impellers 1 in a radial direction. The diffusers 3 convert dynamic pressure of the fluid flowing out from the centrifugal impellers 1 to static pressure.

A return channel 4 (see FIG. 1) that is a flow path for guiding the fluid to the centrifugal impeller 1 of a subsequent stage is provided downstream of one of the diffusers 3.

### <Centrifugal Impeller 1>

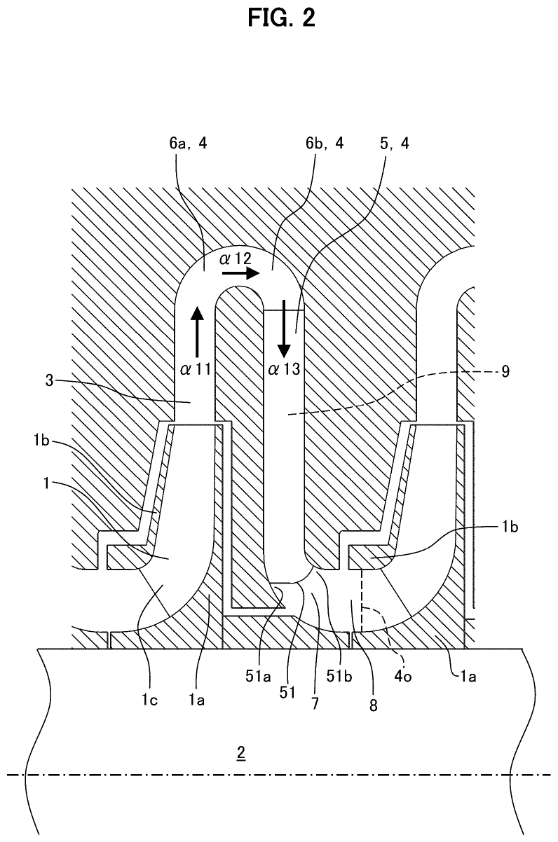

FIG. 2 shows a partial enlarged cross-sectional view of a main portion of the centrifugal compressor 100 shown in FIG. 1.

Each of the centrifugal impellers 1 includes a hub (disc) 1a, a shroud (side plate) 1b, and multiple blades 1c.

The hub (disc) 1a is fastened to the rotational shaft 2.

The shroud 1b is arranged to face the hub 1a.

The multiple blades 1c are located between the hub 1a and the shroud 1b. The multiple blades 1c are arranged at intervals in a circumferential direction about the rotational shaft 2.

Multiple centrifugal impellers 1 are attached to the rotational shaft 2. Note that FIG. 1 shows the case where two sets (two stages) of centrifugal impellers 1 are provided.

### <Diffuser 3>

Either a diffuser 3 with vanes shown in FIG. 1 or a vane-less diffuser 3 shown in FIG. 2 is used as each of the diffusers 3.

In the diffuser 3 with vanes shown in FIG. 1, multiple vanes 3y are arranged at a substantially equal pitch in the circumferential direction about the rotational shaft 2. The vane-less diffuser 3 shown in FIG. 2 has no vanes.

### <Return Channel 4>

As shown in FIG. 2, the return channel 4 shown in FIG. 1 includes a turnaround portion 6a, a turnaround portion 6b, and a return vane 5.

The turnaround portion 6a turns the flow of the fluid having flowed through the diffuser 3 in an outward radial direction (arrow all in FIG. 2), from the outward radial direction to an axial direction (arrow a12 in FIG. 2).

The turnaround portion 6b turns the flow of the fluid in the axial direction (arrow a12 in FIG. 2), to an inward radial direction (arrow a13 in FIG. 2).

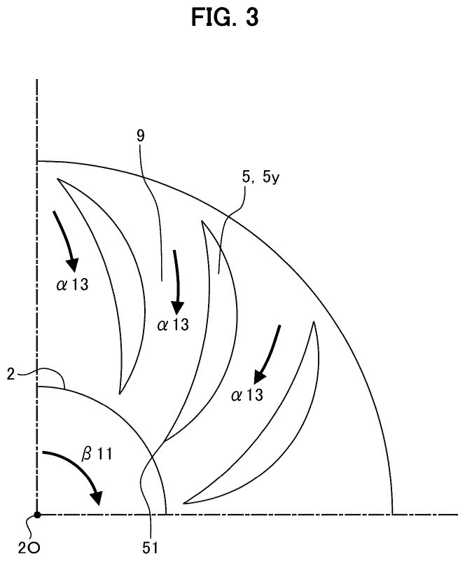

FIG. 3 shows a cross-sectional view in which the return vane 5 is viewed in the axial direction.

The return vane 5 is formed of multiple vanes 5y arranged at a substantially equal pitch in the circumferential direction about a center axis 20 of the rotational shaft 2.

The return vane 5 removes a swirl component in a rotation direction (arrow ß11 in FIG. 3) of the centrifugal impeller 1 that the fluid flowing in the inward radial direction (arrows a13 in FIG. 2) has.

The return vane 5 has a role of causing the fluid (arrows a13 in FIG. 3) passing a radial flow path 9 (see FIG. 3) to flow into the downstream centrifugal impeller 1 of the next stage while removing a swirl velocity component of the fluid and straightening the flow of the fluid.

### <Casing 30>

As shown in FIG. 1, the centrifugal impeller 1, the diffuser 3, and the return channel 4 are housed in a casing 30.

The casing 30 is supported by a flange 31a on one side in an extending direction of the rotational shaft 2 and a flange 31b on the other side.

### <Intake Flow Path 32 and Discharge Flow Path 33>

An intake flow path 32 is provided on the intake side that is the upstream side of the flow of the fluid in the casing 30 shown in FIG. 1. Meanwhile, a discharge flow path 33 is provided on the discharge side that is the downstream side of the flow of the fluid in the casing 30.

The fluid before compression is taken in from the intake flow path 32 as shown by the arrow β1 in FIG. 1.

The pressure of the fluid taken in from the intake flow path 32 is increased every time the fluid passes the centrifugal impeller 1, the diffuser 3, and the return channel 4 of each stage.

The fluid whose pressure is increased is discharged from the discharge flow path 33 as shown by the arrow 32 in FIG. 1. The fluid is thereby eventually discharged from the discharge flow path 33 with its pressure adjusted to predetermined pressure.

### <Return Vane 5>

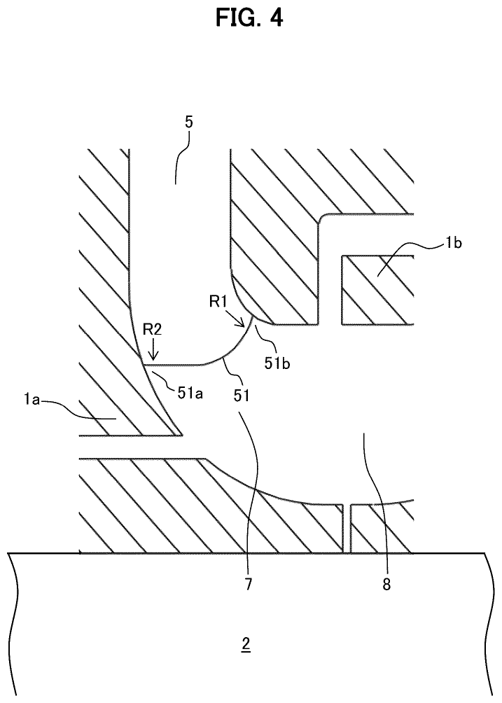

FIG. 4 shows an enlarged cross-sectional view of a return vane rear edge 51 according to the present invention.

In the return vane 5, the return vane rear edge 51 located at a downstream end is extended toward the inner radial side to an inside of an L-shaped bend flow path 7 to secure a sufficient vane length of the return vane 5. In detail, a portion of the return vane rear edge 51 near a hub-side connection part 51a on the hub 1a side has a linear shape. Specifically, the portion of the return vane rear edge 51 near the hub-side connection part 51a is not curved (curvature radius R2=∞).

Meanwhile, a portion of the return vane rear edge 51 near a shroud-side connection part 51b on the shroud 1b side has a curved shape protruding toward the rotational shaft 2 (downward in FIG. 4) (curvature radius R1). The portion near the shroud-side connection part 51b has a curved shape protruding downstream.

Moreover, the curved shape of the return vane rear edge 51 is exposed to an axial flow path 8. In other words, the curved shape of the return vane rear edge 51 is on an extension of the axial flow path 8. Meanwhile, the shroud-side connection part 51b of the return vane rear edge 51 is not on the extension of the axial flow path 8. In other words, the shroud-side connection part 51b of the return vane rear edge 51 is not exposed to the axial flow path 8.

Furthermore, the curve radius R1 of the shroud-side connection part 51 of the return vane rear edge 51 is smaller than the curve radius R2 of the hub-side connection part 51a.

Since the hub-side connection part 51a has the linear shape, the curve radius R2 is infinite.

The hub-side connection part 51a of the return vane rear edge 51 is on the inner radial side (rotational shaft 2 side) of the shroud-side connection part 51b.

This suppresses an increase of the vane length of the return vane 5 on the hub 1a side and suppresses an increase of a counter-swirl velocity component on the hub 1a side, while increasing the vane length in an area from the shroud 1b side where a pre-swirl velocity component is large to a portion near a flow path height center (portion near a midway point of the hub-side connection part 51a and the shroud-side connection part 51b).

The above-mentioned configuration can reduce the pre-swirl velocity component in a region near the shroud-side connection part 51b.

Note that the pre-swirl velocity component refers to +(positive) velocity component in the rotation direction of the rotational shaft 2. Meanwhile, the counter-swirl velocity component refers to a− (negative) velocity component in the opposite direction to the rotation direction of the rotational shaft 2.

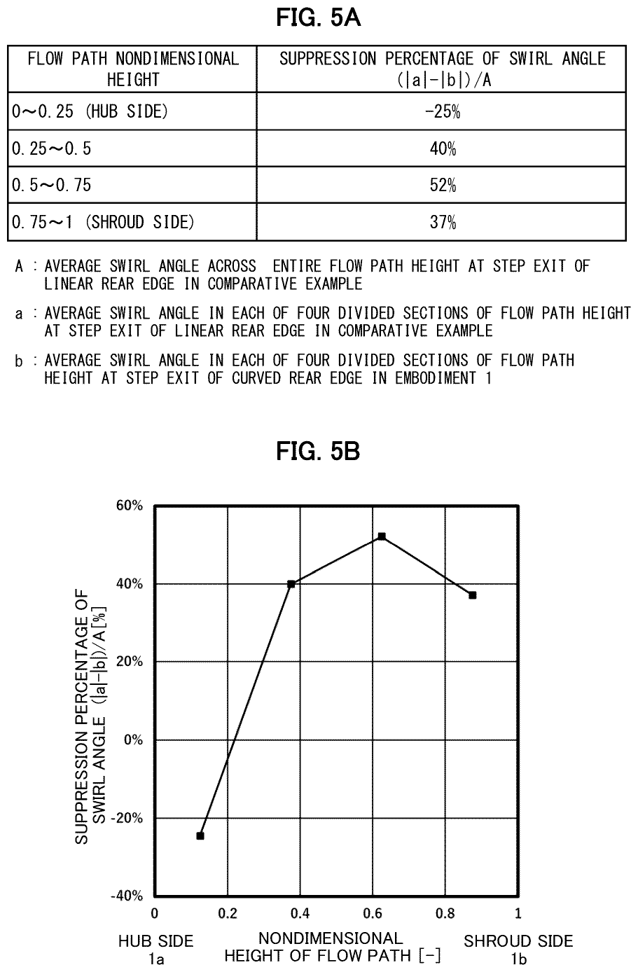

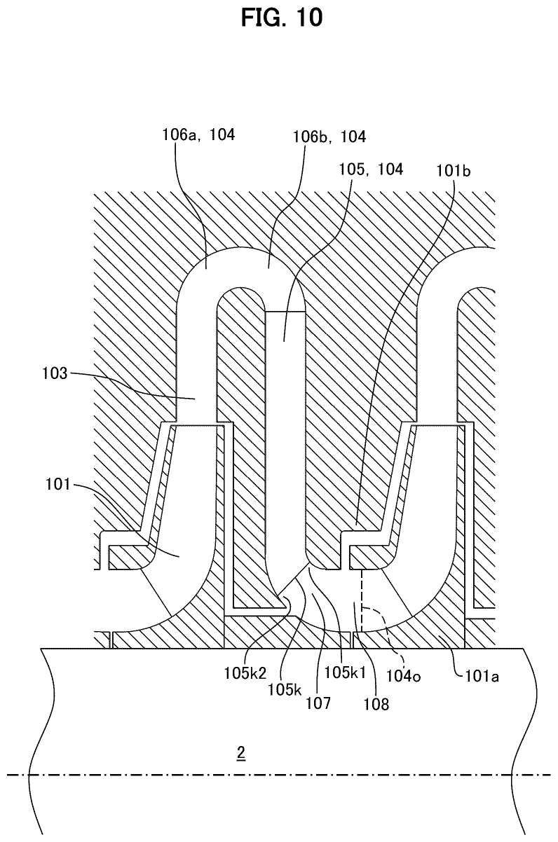

FIG. 5A shows a fluid analysis result of a suppression percentage of a swirl angle in the axial flow paths 108 and 8 in the case where the return vane rear edge 105k with a linear shape in the conventional design (comparative example) shown in FIG. 10 is replaced with the return vane rear edge 51 with the curved shape in Embodiment 1 shown in FIG. 2. The suppression percentage of the swirl angle is defined as (|a|−|b|)/A, where A is an average swirl angle across the entire flow path height in the return vane rear edge 105k with the linear shape, a is an average swirl angle in each of four divided sections of the flow path height in the return vane rear edge 105k with the linear shape, and b is an average swirl angle in each of four divided sections of the flow path height in the return vane rear edge 51 with the curved shape in Embodiment 1. Since the swirl angle (deg) is ideally 0, both of a+ (positive) swirl velocity in the same direction as the rotation direction of the rotational shaft 2 and a− (negative) velocity component in the opposite direction need to be evaluated by using the magnitudes of absolute values. Since a difference between the absolute values of the respective average swirl angles a and b in each of the four divided sections of the flow path height is set as a numerator of the suppression percentage of the swirl angle, the suppression percentage of the swirl angle expresses a degree of improvement in the swirl angle in the case where the conventional design (comparative example) is replaced with Embodiment 1.

FIG. 5B shows a graph of the fluid analysis result of the suppression percentage of the swirl angle in the axial flow paths 108 and 8 in the case where the return vane rear edge 105k with the linear shape in the conventional design (comparative example) shown in FIG. 10 is replaced with the return vane rear edge 51 with the curved shape in Embodiment 1 shown in FIG. 2.

In the conventional design (comparative example) shown in FIG. 10, the swirl angle (deg) is measured at a stage exit 104o of the axial flow path 108. A range from the hub 101a side to the shroud 101b side of the axial flow path 108 shown in FIG. 10 is nondimensionalized, and the hub 101a side is set as 0 while the shroud 101b side is set as 1. In Embodiment 1 shown in FIG. 2, the swirl angle (deg) is measured at a stage exit 40 of the axial flow path 8. As in the comparative example, a range from the hub 1a side to the shroud 1b side of the axial flow path 8 shown in FIG. 2 is nondimensionalized, and the hub 1a side is set as 0 while the shroud 1b side is set as 1.

As found from FIG. 5A, the suppression percentage of the swirl angle in a flow path nondimensional height of 0 to 0.25is −25 %. In this flow path nondimensional height, the flow has a− (negative) velocity component in the opposite direction to the rotation direction of the rotational shaft 2, and replacing the conventional design (comparative example) with Embodiment 1 increases this velocity component in the opposite direction. Meanwhile, in a flow path nondimensional height of 0.25 to 1, the suppression percentage of the swirl angle is 37% to 52%. In this flow path nondimensional height, the flow has a + (positive) velocity component in the rotation direction of the rotational shaft 2, and replacing the conventional design (comparative example) with Embodiment 1 suppresses this + (positive) velocity component. In FIG. 5B, it can be confirmed that, although the suppression percentage of the swirl angle is negative in an area near the hub 1a, the suppression percentage of the swirl angle is high in the area from the flow path height center to the shroud 1b side. Since the swirl angle on the shroud 1b side greatly affects the pressure increase of the fluid by the centrifugal impeller 1 more than that on the hub 1a side, a performance improvement of the compressor is expected when the suppression percentage of the swirl angle is positive in the area from the flow path center to the shroud 1b side even if the suppression percentage of the swirl angle is negative in the area near the hub 1a side.

From the results of FIGS. 5A and 5B, it can be confirmed that replacing the conventional design (comparative example) with Embodiment 1 can reduce the swirl velocity component in the area from the shroud 1b side where the pre-swirl velocity component is large to the portion near the flow path height center, while suppressing the increase of the counter-swirl velocity component on the hub 1a side.

According to Embodiment 1, devising a shape of the rear edge 51 of the return vane 5 can reduce the swirl velocity component in the entire return vane 5 connected from the shroud 1b to the hub 1a in the flow path height direction, also when the size of the centrifugal compressor 100 is reduced.

Note that the swirl velocity component refers to both of the +(positive) velocity component in the rotation direction of the rotational shaft 2 and the-(negative) velocity component in the opposite direction to the rotation direction of the rotational shaft 2.

Note that it is ideal that the average swirl velocity component is 0 and the tangent is 0°.

Note that the centrifugal compressor including multiple centrifugal impellers 1 is referred to as multistage centrifugal compressor.

### Embodiment 2

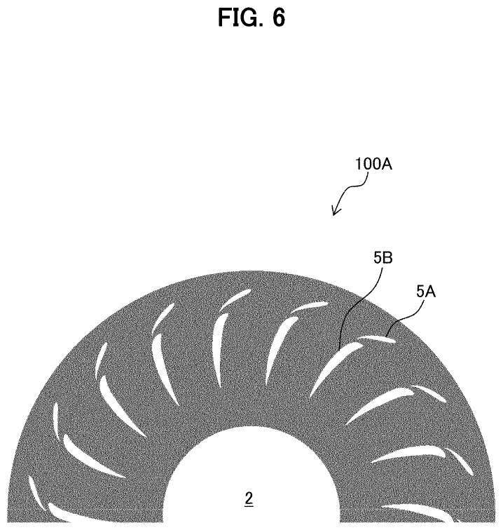

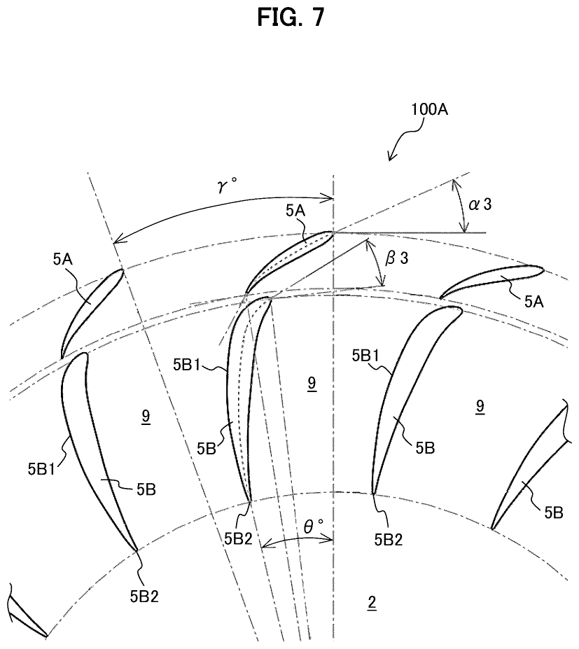

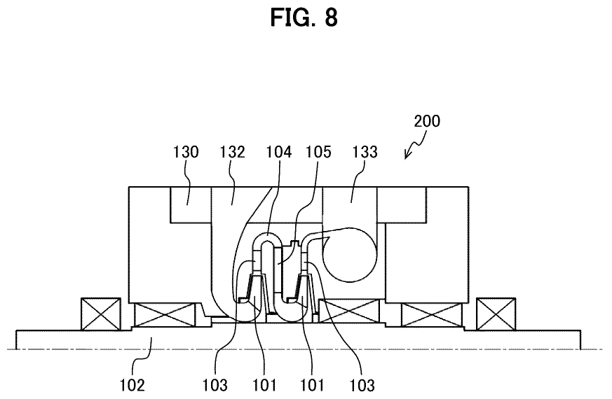

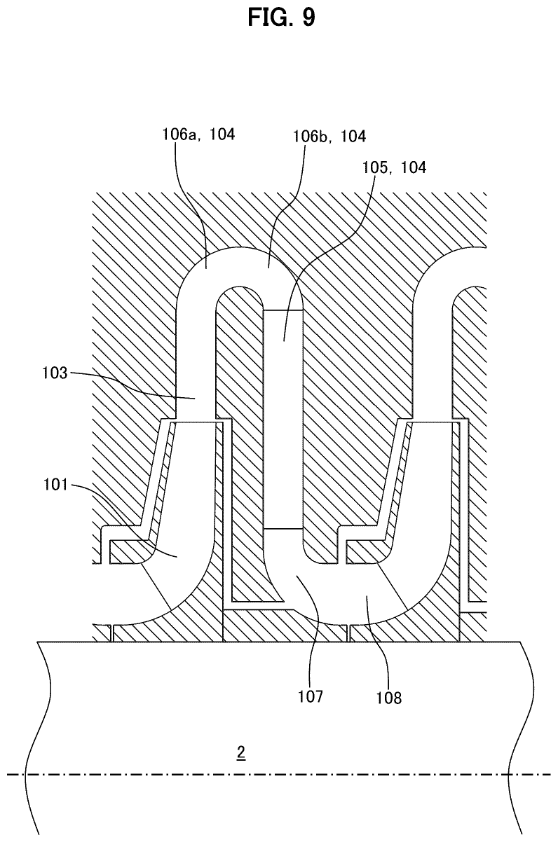

A centrifugal compressor of Embodiment 2 in the present invention is explained below by using FIGS. 6 and 7.

FIG. 6 shows a cross-sectional view in which a return vane divided into two rows of front vanes 5A and rear vanes 5B in Embodiment 2 are viewed in the axial direction.

FIG. 7 shows a positional relationship of the front vanes 5A and the rear vanes 5B shown in FIG. 6 in Embodiment 2.

The centrifugal compressor 100A of Embodiment 2 is a case where the compressor includes tandem (two) return vanes of the front vanes 5A and the rear vanes 5B.

When the length of the return vane 5 in the radial direction is reduced for further size reduction of the centrifugal compressor, a turn amount of the flow required between the entrance and the exit of the return vane 5 increases with respect to the length of the centrifugal impeller 1. Accordingly, there is a risk of occurrence of separation of the flow from the return vane 5, and an improvement in efficiency may not be achieved.

In order to solve this problem, in the centrifugal compressor 100A of Embodiment 2, multiple front vanes 5A are arranged in a circle about the rotational shaft 2, on the upstream side (outer radial side) of the flow of the fluid in the radial flow path 9. Moreover, multiple rear vanes 5B are arranged in a circle about the rotational shaft 2, on the downstream side (inner radial side) of the flow of the fluid in the radial flow path 9.

Embodiment 2 is characterized in that, as shown in FIG. 7, an inlet blade angle α3 of the rear vanes 5B provided on the downstream side in the return vane 5 is more laid down in the circumferential direction than an inlet blade angle α3 of the front vanes 5A provided on the upstream side in the return vane 5.

Specifically, the inlet blade angle 33 of the rear vanes 5B and the inlet blade angle α3 of the front vanes 5A in the return vane 5 are set to satisfy a relationship of β3<α3 (the inlet blade angle α3 of the front vanes 5A is larger) to cause the fluid to flow in from the suction surface 5B1 side of the rear vanes 5B while flowing.

This can increase the pressure in the radial flow path 9 formed between the vanes of the front vanes 5A and the rear vanes 5B in the return vane 5, and increase the flow rate of the flow passing the radial flow path 9. When the flow rate increases, the momentum of the flow passing the suction surfaces 5B1 of the rear vanes 5B increases. Accordingly, the separation of the flow that occurs on the suction surfaces 5B1 of the rear vanes 5B can be suppressed.

Suppressing the separation of the flow can achieve both of turning of the flow and suppression of an efficiency decrease with the separation.

Moreover, in Embodiment 2, a rear edge 5B2 of each rear vane 5B is extended toward the inner radial side to the inside of the bend flow path 7 (see FIG. 2) like the return vane rear edge 51 in Embodiment 1. Moreover, the rear edge 5B2 of the rear vane 5B has a curved shape protruding toward the rotational shaft 2. Furthermore, the curve radius of the rear edge 5B2 of the rear vane 5B on the shroud 1b side is smaller than that on the hub 1a side, and the hub-side connection part 51a is on the inner radial side of the shroud-side connection part 51b as in FIG. 4.

This configuration can suppress the increase in the vane length on the hub 1a side of the return vane 5 and suppress the increase in the counter-swirl velocity component on the hub 1a side of the return vane 5 while reducing the pre-swirl velocity component in the area from the shroud 1b side where the pre-swirl velocity component of the return vane 5 is large to the portion near the flow path height center by increasing the vane length only in this area. Moreover, since the centrifugal compressor 100A is a tandem type including the front vanes 5A and the rear vanes 5B of the return vane, further size reduction is possible.

### Other Embodiments

The present embodiment is not limited to the configurations of the embodiments described above, and various modified embodiments and specific embodiments can be made within the scope of the attached claims.

### REFERENCE SIGNS LIST

1 centrifugal impeller
1b shroud
1a hub
2 rotational shaft
3 diffuser (diffuser flow path)
4 return channel (return flow path)
5 return vane
5A front vane
5B rear vane
51 return vane rear edge
51a hub-side connection part of return vane rear edge
51b shroud-side connection part of return vane rear edge
6a return bend that turns fluid from outward radial direction to axial direction
6b return bend that turns fluid from axial direction to inward radial direction
7 L-shaped bend flow path (bend portion)
8 axial flow path
9 radial flow path
100, 100A centrifugal compressor (multistage centrifugal compressor)
R1 curve radius on shroud side
R2 curve radius on hub side
α3 inlet blade angle of front vanes
β3 inlet blade angle of rear vanes
A average swirl angle across entire flow path height at step exit of linear rear edge in comparative example
a average swirl angle in each of four divided sections of flow path height at step exit of linear rear edge in comparative example
b average swirl angle in each of four divided sections of flow path height at step exit of curved rear edge in Embodiment 1

1. A multistage centrifugal compressor comprising:
a rotational shaft;
a centrifugal impeller fixed to the rotational shaft; and
a return flow path formed by a shroud and a hub, wherein in the return flow path, a radial flow path, an L-shaped bend flow path, and an axial flow path form an L-shaped flow path,
a return vane is arranged in the radial flow path and the L-shaped bend flow path,
a portion of a rear edge of the return vane near a hub-side connection part has a linear shape and a portion of the rear edge of the return vane near a shroud-side connection part has a curved shape protruding downstream, the rear edge of the return vane extended toward an inner radial side to an inside of the L-shaped bend flow path, and
the hub-side connection part of the return vane is on the inner radial side of the shroud-side connection part.

2. A multistage centrifugal compressor comprising:
a rotational shaft;
an impeller fixed to the rotational shaft;
a diffuser flow path located on an outer radial side of the impeller, and
a return flow path formed by a shroud and a hub and configured to return a fluid flowing in the diffuser flow path toward the rotational shaft, wherein
the return flow path includes a radial flow path through which the fluid flows from the outer radial side to an inner radial side, an axial flow path through which the fluid flows along the rotational shaft, a bend portion connecting the radial flow path and the axial flow path, and a return vane formed to extend from the radial flow path to the bend portion,
a hub-side connection part of a rear edge of the return vane is on the inner radial side of a shroud-side connection part of the rear edge, and the rear edge has a curved shape protruding toward the rotational shaft, and
the curved shape of the rear edge is on an extension of the axial flow path, or is exposed to the axial flow path.

3. The multistage centrifugal compressor according to claim 1, wherein the shroud-side connection part of the return vane is not on an extension of the axial flow path or is not exposed to the axial flow path.

4. The multistage centrifugal compressor according to claim 1, wherein a curve radius of the rear edge of the return vane on the shroud side is smaller than a curve radius of the rear edge of the return vane on the hub side.

5. The multistage centrifugal compressor according to claim 1, wherein the portion of the rear edge of the return vane near the hub-side connection part is not curved.

6. The multistage centrifugal compressor according to claim 1, wherein the return vane is a tandem type.

7. The multistage centrifugal compressor according to claim 1, wherein
the return vane is a front vane provided on an upstream side and a rear vane provided on a downstream side, and
an inlet blade angle of the front vane is larger than an inlet blade angle of the rear vane.

8. The multistage centrifugal compressor according to claim 2, wherein the shroud-side connection part of the return vane is not on an extension of the axial flow path or is not exposed to the axial flow path.

9. The multistage centrifugal compressor according to claim 2, wherein a curve radius of the rear edge of the return vane on the shroud side is smaller than a curve radius of the rear edge of the return vane on the hub side.

10. The multistage centrifugal compressor according to claim 2, wherein the portion of the rear edge of the return vane near the hub-side connection part is not curved.

11. The multistage centrifugal compressor according to claim 2, wherein the return vane is a tandem type.

12. The multistage centrifugal compressor according to claim 2, wherein
the return vane is a front vane provided on an upstream side and a rear vane provided on a downstream side, and
an inlet blade angle of the front vane is larger than an inlet blade angle of the rear vane.
